(19) United States
(12) Patent Application Publication
(10) Pub. No.: US 2006/0085647 A1
(43) Pub. Date: Apr. 20, 2006

(54) Detecting compromised ballots

(76) Inventor: C. Andrew Neff, Bellevue, WA (US)

Correspondence Address: PERKINS COIE LLP;PATENT-SEA, P.O. BOX 1247, SEATTLE, WA, 98111-1247, US

(21) Appl. No.: 11/293,459

(22) Filed: Dec. 1, 2005

Related U.S. Application Data
(62) Division of application No. 10/081,863, filed on Feb. 20, 2002.
(63) Continuation-in-part of application No. 09/816,869, filed on Mar. 24, 2001, now Pat. No. 6,950,948.
(63) Continuation-in-part of application No. 09/535,927, filed on Mar. 24, 2000, now abandoned.
(60) Provisional application No. 60/270,182, filed on Feb. 20, 2001.
(60) Provisional application No. 60/355,857, filed on Feb. 11, 2002.

(51) Int. Cl. H04L 9/00

(52) U.S. Cl. 713/180

(57) ABSTRACT

A facility for transmitting a ballot choice selected by a voter is described. The facility encrypts the ballot choice with a first secret known only to the client to generate a first encrypted ballot component. The facility also encrypts the ballot choice with a second secret known only to the client, the second secret chosen independently of the first secret, to generate a second encrypted ballot component. The facility then generates a proof demonstrating that the first and second encrypted ballot components are encrypted from the same ballot choice. The facility sends the first and second encrypted ballot components and the proof to a vote collection computer system.

### RELATED APPLICATIONS

This application claims the benefit of U.S. Provisional Application No. 60/270,182 filed Feb. 20, 2001, claims the benefit of U.S. Provisional Application No. ______ (patent counsel's docket number 32462-8006US02) filed Feb. 11, 2002, and is a continuation-in-part of each of U.S. patent application Ser. No. 09/534,836, filed Mar. 24, 2000; U.S. patent application Ser. No. 09/535,927, filed Mar. 24, 2000; and U.S. patent application Ser. No. 09/816,869 filed Mar. 24, 2001. Each of these five applications is incorporated by reference in its entirety.

### TECHNICAL FIELD

The present invention is directed to the fields of election automation and cryptographic techniques therefor.

### BACKGROUND

The problems of inaccuracy and inefficiency have long attended conventional, manually-conducted elections. While it has been widely suggested that computers could be used to make elections more accurate and efficient, computers bring with them their own pitfalls. Since electronic data is so easily altered, many electronic voting systems are prone to several types of failures that are far less likely to occur with conventional voting systems.

One class of such failures relates to the uncertain integrity of the voter's computer, or other computing device. In today's networked computing environment, it is extremely difficult to keep any machine safe from malicious software. Such software is often able to remain hidden on a computer for long periods of time before actually performing a malicious action. In the meantime, it may replicate itself to other computers on the network, or computers that have some minimal interaction with the network. It may even be transferred to computers that are not networked by way of permanent media carried by users.

In the context of electronic secret ballot elections, this kind of malicious software is especially dangerous, since even when its malicious action is triggered, it may go undetected, and hence left to disrupt more elections in the future. Controlled logic and accuracy tests (“L&A tests”) monitor the processing of test ballots to determine whether a voting system is operating properly, and may be used in an attempt to detect malicious software present in a voter's computer. L&A tests are extremely difficult to conduct effectively, however, since it is possible that the malicious software may be able to differentiate between “real” and “test” ballots, and leave all “test” ballots unaffected. Since the requirement for ballot secrecy makes it impossible to inspect “real” ballots for compromise, even exhaustive L&A testing may prove futile. The problem of combating this threat is known as the “Client Trust Problem.”

Most existing methods for solving the Client Trust Problem have focused on methods to secure the voting platform, and thus provide certainty that the voter's computer is “clean,” or “uninfected.” Unfortunately, the expertise and ongoing diligent labor that is required to achieve an acceptable level of such certainty typically forces electronic voting systems into the controlled environment of the poll site, where the client computer systems can be maintained and monitored by computer and network experts. These poll site systems can still offer some advantages by way of ease of configuration, ease of use, efficiency of tabulation, and cost. However, this approach fails to deliver on the great potential for distributed communication that has been exploited in the world of e-commerce.

Accordingly, a solution to the Client Trust Problem that does not require the voting platform to be secured against malicious software, which enables practically any computer system anywhere to be used as the voting platform, would have significant utility.

### BRIEF DESCRIPTION OF DRAWINGS

FIG. 1 is a high-level block diagram showing a typical environment in which the facility operates.

FIG. 2 is a block diagram showing some of the components typically incorporated in at least some of the computer systems and other devices on which the facility executes.

FIG. 3 is a flow diagram showing steps typically performed by the facility in order to detect a compromised ballot.

### DETAILED DESCRIPTION

A software facility for detecting ballots compromised by malicious programs (“the facility”) is provided. The approach employed by the facility typically makes no attempt to eliminate, or prevent the existence of malicious software on the voting computer. Instead, it offers a cryptographically secure method for the voter to verify the contents of the voter's ballot as it is received at the vote collection center, without revealing information about the contents (ballot choices) to the collection center itself. That is, the vote collection center can confirm to the voter exactly what choices were received, without knowing what those choices are. Thus, the voter can detect any differences between the voter's intended choices, and the actual choices received at the vote collection center (as represented in the transmitted voted ballot digital data). Further, each election can choose from a flexible set of policy decisions allowing a voter to re-cast the voter's ballot in the case that the received choices differ from the intended choices.

The facility is described in the context of a fairly standard election setting. For ease of presentation, initial discussion of the facility assumes that there is only one question on the ballot, and that there are a set of K allowable answers, a₁, . . . ,a_{K} (one of which may be “abstain”). It will be appreciated by those of ordinary skill in the art that it is a straightforward matter to generalize the solution given in this situation to handle the vast majority of real world ballot configurations.

Several typical cryptographic features of the election setting are:
1. Ballot Construction: A set of cryptographic election parameters are agreed upon by election officials in advance, and made publicly known by wide publication or other such means. Significant parameters are the encryption group, generator, election public key and decision encoding scheme. More specifically, these are:
   (a) The encryption group, G may be Zₚ, with p a large prime, or an elliptic curve group.
   (b) The generator, gεG. In the case G=Zₚ, g should generate a (multiplicative) subgroup, <g>, of G* which has large prime order q. In the elliptic curve case we assume <g>=G and q=p.
   (c) The election public key, hε<g>.
   (d) The decision encoding scheme: A partition of <g> into “answer representatives.” That is, <g>=S₀∪S₁∪ . . . S_{K}, where the Sₖ are pair wise disjoint subsets of <g>. For each 1≦k≦K, any message mεSₖ represents a vote for aₖ. The remaining messages, mεS₀ are considered invalid. Typically, each Sₖ, 1≦k≦K, consists of a single element, μₖ, though this is not, fundamentally, a requirement. For the security of the scheme, however, it is generally required that the μₖ are generated independently at random either using some public random source, or by an acceptable sharing scheme.

While the following discussion uses multiplicative group notation for the sake of consistency, it should be clear that all constructions can be implemented equally well using elliptic curves.
2. Vote Submission: Each voter, νᵢ, encrypts her vote, or decision, as an ElGamal pair, (Xᵢ, Yᵢ)=(g^{α}^{ᵢ}, h^{α}^{ᵢ}, mᵢ), where αᵢεZ_{q} is chosen randomly by the voter, and mᵢεSₖ if νᵢ wishes to choose answer aₖ. This encrypted value is what is transmitted to the vote collection center (cast), usually with an attached digital signature created by νᵢ.

If the voter, νᵢ, were computing these values herself—say with pencil and paper—this protocol would essentially suffice to implement a secret ballot, universally verifiable election system. (Depending on the tabulation method to be used, some additional information, such as a voter proof of validity would be necessary.) However, since in practice, νᵢ only makes choices through some user interface, it is not realistic to expect her to observe the actual value of the bits sent and check them for consistency with her intended choice. In short, the vote client can ignore voter intent and submit a “μⱼ vote” when the voter actually wished to submit a “μₖ vote.”

The voter typically needs some way to verify that the encrypted vote which was received at the vote collection center is consistent with her choice. Simply making the ballot box data public does not a reasonable solution, since the vote client, not the voter, chooses αᵢ. For reasons of vote secrecy, and coercion, this value should be “lost.” So νᵢ's encrypted vote is as opaque to her as it is to anyone else. A generic confirmation from the vote collection center is obviously not sufficient either. The general properties of what is needed are properties:
1. The confirmation string, C, returned by the vote collection center, needs to be a function of the data (encrypted vote) received.
2. The voter and vote client should be able to execute a specific set of steps that allow the voter to tie C exclusively to the choice (or vote), μₖ, that was received.
3. It should be impossible for the vote client to behave in such a way that the voter “is fooled.” That is, the client can not convince the voter that μₖ was received, when actually, μ≠μₖ was received.

In this section, we present such a scheme, which we shall refer to as SVC, in its basic form. In following sections, we offer some improvements and enhancements.

The following steps are typically performed as part of the voting process.
CC-1. The vote client, Mᵢ, “operated by” νᵢ, creates an encrypted ballot on behalf of νᵢ as before. Let us denote this by (Xᵢ, Yᵢ) (g^{α}^{ᵢ}, h^{α}^{ᵢ}mᵢ), for some value mᵢε<g> and αᵢεZ_{q}.
CC-2. Mᵢ is also required to construct a validity proof, Pᵢ, which is a zeroknowledge proof that mᵢε{μ₁, . . . ,μ_{K}}. (Such a proof is easily constructed from the basic Chaum-Pederson proof for equality of discrete logarithms using the techniques of [CDS94]. See [CGS97] for a specific example.)
CC-3. Mᵢ then submits both Pᵢ and the (signed) encrypted vote, (Xᵢ,Yᵢ) to the vote collection center.
CC-4. Before accepting the encrypted ballot, the vote collection center first checks the proof, Pᵢ. If verification of Pᵢ fails, corruption has already been detected, and the vote collection center can either issue no confirmation string, or some default random one.
CC-5. Assuming then that verification of Pᵢ succeeds, the vote collection center computes the values, Wᵢ and Uᵢ as,
   Wᵢ=KᵢYᵢ^{β}^{ᵢ}=Kᵢh^{α}^{ᵢ}^{β}^{ᵢ}mᵢ^{β}^{ᵢ} (1)
   Uᵢ=h^{β}^{ᵢ} (2)
where KᵢεG and βᵢεZ_{q} are generated randomly and independently (on a voter-by-voter basis).
CC-6. The vote collection center then returns (Uᵢ,Wᵢ) to Mᵢ.
CC-7. The client, Mᵢ, computes
   Cᵢ=Vᵢ/Uᵢ^{α}^{ᵢ}=Kᵢmᵢ^{β}^{ᵢ} (3)
and display this string (or, more likely, a hash of it, H(Cᵢ)) to the voter, νᵢ.

The voter needs to know which confirmation string to look for. This can be accomplished in two different ways. The most straightforward is to have the voter, νᵢ, obtain Kᵢ and βᵢ from the vote collection center. This is workable, requires very little data to be transferred, and may be well suited to some implementations. However, in other situations, it may be an unattractive approach because Cᵢ (or H(Cᵢ)) must then be computed. Since asking Mᵢ to perform this computation would destroy the security of the scheme, νᵢ must have access to an additional computing device, as well as access to the independent communication channel.

An alternative is to have the vote collection center compute all possible confirmation strings for νᵢ, and send what amounts to a confirmation dictionary to νᵢ via the independent channel. In general, the confirmation dictionary for voter νᵢ would consist of the following table laid out in any reasonable format:

| Answer | Confirmation String |
|---|---|
| α₁ | H(Cᵢ₁) |
| α₂ | H(Cᵢ₂) |
| . | . |
| . | . |
| . | . |
| α_{K} | H(C_{iK}) |

where H is the election's public (published) hash function (possibly the identity function), and Cᵢⱼ=Kᵢμⱼ^{β}^{ᵢ}.

Of course care must be used in engineering the independent channel to be sure that it really is independent. Ideally, it should be inaccessible to devices connected to the voting network. Solutions are available, however. Since the Kᵢ and βᵢ can be generated in advance of the election, even slow methods of delivery, such as surface mail, can be employed to transmit the dictionary.

In order to more completely describe the facility, an example illustrating the operation of some of its embodiments is described. The following is a detailed example of a Secret Value Confirmation exchange.

In order to maximize the clarity of the example, several of the basic parameters used—for example, the number of questions on the ballot, and the size of the cryptographic parameters—are much smaller than those that would be typically used in practice. Also, while aspects of the example exchange are discussed below in a particular order, those skilled in the art will recognize that they may be performed in a variety of other orders.

Some electronic election protocols include additional features, such as:
voter and authority certificate (public key) information for authentication and audit
ballot page style parameters
data encoding standards
tabulation protocol and parameters

As these features are independent of the Secret Value Confirmation implementation, a detailed description of them is not included in this example.

This example assumes an election protocol that encodes voter responses (answers) as a single ElGamal pair. However, from the description found here, it is a trivial matter to also construct a Secret Value Confirmation exchange for other election protocols using ElGamal encryption for the voted ballot. For example, some embodiments of the facility incorporate the homomorphic election protocol described in U.S. patent application Ser. No. 09/535,927. In that protocol, a voter response is represented by multiple ElGamal pairs. The confirmation dictionary used in this example is easily modified to either display a concatenation of the respective confirmation strings, or to display a hash of the sequence of them.

The jurisdiction must first agree on the election initialization data. This at least includes: the basic cryptographic numerical parameters, a ballot (i.e., a set of questions and allowable answers, etc.) and a decision encoding scheme. (It may also include additional data relevant to the particular election protocol being used.)

Cryptographic Parameters

Group Arithmetic: Integer multiplicative modular arithmetic
Prime Modulus: p=47
Subgroup Modulus: q=23
Generator: g=2
Public Key: h=g^{s} where s is secret. For the sake of this example, let us say that h=g¹²=7.
   Ballot
One Question
   Question 1 Text: Which colors should we make ourflag? (Select at most 1.)
   Number of answers/choices: 4
      Answer 1 Text: Blue
      Answer 2 Text: Green
      Answer 3 Text: Red
      Answer 4 Text: I abstain

Decision Encoding Scheme

| Choice | Response Value |
|---|---|
| Blue | 9(μ₁) |
| Green | 21(μ₂) |
| Red | 36(μ₃) |
| I abstain | 17(μ₄) |

At some point, before issuing a confirmation and before distributing the voter confirmation dictionaries, the ballot collection center (or agency) generates random, independent βᵢ and Kᵢ for each voter, Vᵢ. If the confirmation dictionary is to be sent after vote reception, these parameters can be generated, on a voter by voter basis, immediately after each voted ballot is accepted. Alternatively, they can be generated in advance of the election. In this example, the ballot collection agency has access to these parameters both immediately after accepting the voted ballot, and immediately before sending the respective voter's confirmation dictionary.

Sometime during the official polling time, each voter, V, obtains and authenticates the election initialization data described above. It can be obtained by submitting a “ballot request” to some ballot server. Alternatively, the jurisdiction may have some convenient means to “publish” the election initialization data—that is, make it conveniently available to all voters.

From the election initialization data, V is able to determine that the expected response is the standard encoding of a particular sequence of two distinct data elements. These are (in their precise order):

Choice Encryption

A pair of integers (X, Y) with 0≦X, Y<47 indicating (in encrypted form) the voter's choice, or answer. For the answer to be valid, it must be of the form, (X, Y)=(2^{α}, 7^{α}μ), where 0≦α≦23 and με{9, 21, 36, 17}.

Proof of Validity

A proof of validity showing that (X, Y) is of the form described in the choice encryption step above. (In this example, we shall see that this proof consists of 15 modular integers arranged in specific sequence.)

For the sake of this example, let us assume that V wishes to cast a vote for “Green.”
1. V generates αεZ₂₃ randomly. In this example, α=5. Since the encoding of “Green” is 21, V's choice encryption is computed as
   (X,Y)=(2⁵,7⁵×21)=(32,24) (4)
This pair is what should be sent to the vote collection center. The potential threat is that V's computer may try to alter these values.

Voter V (or more precisely, V's computer) must prove that one of the following conditions hold
1. (X, Y)=(2^{α}, 7^{α}×9) i.e. choice (vote cast) is “Blue”
2. (X, Y)=(2^{α}, 7^{α}×21) i.e. choice (vote cast) is “Green”
3. (X, Y)=(2^{α}, 7^{α}×36) i.e. choice (vote cast) is “Red”
4. (X, Y)=(2^{α}, 7^{α}×17) i.e. choice (vote cast) is “I abstain”
   for some unspecified value of α without revealing which of them actually does hold.

There are a variety of standard methods that can be used to accomplish this. See, for example, R. Cramer, I. Damgård, B. Schoenmakers, Proofs of partial knowledge and simplified design of witness hiding protocols, Advances in Cryptology—CRYPTO '94, Lecture Notes in Computer Science, pp. 174-187, Springer-Verlag, Berlin, 1994. The Secret Value Confirmation technique used by the facility works equally well with any method that satisfies the abstract criteria of the previous paragraph. While details of one such validity proof method are provided below, embodiments of the facility may use validity proofs of types other than this one.

Validity Proof Construction:

(In what follows, each action or computation which V is required to perform is actually carried out by V's computer.)
1. V sets α₂=α=5.
2. V generates ω₂ε_{R} Z₂₃, r₁, r₃, r₄ ε_{R} Z₂₃, s₁, s₃, s₄ε_{R} Z₂₃ all randomly and independently. For this example we take
   ω₂=4
   r₁=16, r₃=17, r₄=21
   s₁=12, s₃=4, s₄=15 (5)
3. V computes corresponding values
   a₁=g^{r}^{₁}X^{-s}^{₁}=2¹⁶×32¹¹=4
   a₂=g^{ω}^{₂}=2⁴=16
   a₃=g^{r}^{₃}X^{-s}^{₃}=2¹⁷×32¹⁹=6
   a₄=g^{r}^{₄}X^{-s}^{₄}=2²¹×32⁸=9 (6)
   b₁=h^{r}^{₁}(Y/9)^{-s}^{₁}=7¹⁶×(24/9)¹¹=18
   b₂=h^{ω}^{₂}=7⁴=4
   b₃=h^{r}^{₃}(Y/36)^{-s}^{₃}=7¹⁷×(24/36)¹⁹=1
   b₄=h^{r}^{₄}(Y/17)^{-s}^{₅}=7²¹×(24/17)⁸=7 (7)
4. V uses a publicly specified hash function H to compute cεZ₂₃ as
   c=H({X,Y,aᵢ,bᵢ}1≦i≦4 (8)
Since many choices of the hash function are possible, for this example we can just pick a random value, say
   c=19. (9)
(In practice, SHA1, or MD5, or other such standard secure hash function may be used to compute H.)
5. V computes the interpolating polynomial P(x) of degree 4−1=3. The defining properties of P are
   P(0)=c=19
   P(1)=s₁=12
   P(3)=s₃=4
   P(4)=s₄=15 (10)
P(x)=Σⱼ₌₀³zⱼx^{j} is computed using standard polynomial interpolation theory, to yield:
   P(x)=x³+20x²+18x+19 (11)
or
   z₀=19 z₁=18
   z₂=20 z₃=1 (12)
6. V computes the values
   s₂=P(2)=5
   r₂=ω₂+α₂s₂=4+5×5=6 (13)
7. V's validity proof consists of the 12 numbers
   {aₖ, bₖ, rₖ}ₖ₌₁⁶ (14)
and the three numbers
   {zₖ}ₖ₌₁³ (15)
in precise sequence. (z₀ need not be submitted since it is computable from the other data elements submitted using the public hash function H.)

Having computed the required choice encryption, (X, Y), and the corresponding proof of validity, V encodes these elements, in sequence, as defined by the standard encoding format. The resulting sequences form V's voted ballot. (In order to make the ballot unalterable, and indisputable, V may also digitally sign this voted ballot with his private signing key. The resulting combination of V's voted ballot, and his digital signature (more precisely, the standard encoding of these two elements) forms his signed voted ballot.) Finally, each voter transmits his (optionally signed) voted ballot back to the data center collecting the votes.

As described above, the voter specific random parameters for V (β and K) are available at the vote collection center. In this example, these are
β=18 K=37 (16)

When the voter's (optionally signed) voted ballot is received at the vote collection center, the following steps are executed
1. The digital signature is checked to determine the authenticity of the ballot, as well as the eligibility of the voter.
2. If the signature in step 1 verifies correctly, the vote collection center then verifies the proof of validity. For the particular type of validity proof we have chosen to use in this example, this consists of
   (a) The public hash function H is used to compute the value of P(0)=z₀
      z₀=P(0)=H({X,Y,aᵢ,bᵢ}ᵢ₌₁⁴)=19 (17)
   (Recall that the remaining coefficients of P, z₁, z₂, z₃, are part of V's (optionally signed) voted ballot submission.)
   (b) For each 1≦j≦4 both sides of the equations
      aⱼ=g^{r}^{ⱼ}xⱼ^{-P(j)}
      bⱼ=h^{rj}(y^{j}/μⱼ)^{-P(j)} (18)
   are evaluated. (Here, as described above, the μⱼ are taken from the Decision Encoding Scheme.) If equality fails in any of these, verification fails. This ballot is not accepted, and some arbitrary rejection string (indication) is sent back to V.
3. Assuming that the previous steps have passed successfully, the reply string (W, U) is computed as
   W=KY^{β}=37×24¹⁸=9
   U=h^{β}=7¹⁸=42 (19)
This sequenced pair is encoded as specified by the public encoding format, and returned to V.
4. V's computer calculates
   C=W/U^{α}=9/(42)⁵=18 (20)
and displays this string to V. (Alternatively, the protocol may specify that a public hash function is computed on C and the resulting hash value displayed. In this example, C itself is displayed.) If V's computer attempted to submit a choice other than “Green,” the value of C computed above would be different. Moreover, the correct value of C cannot be computed from an incorrect one without solving the Diffie-Hellman problem. (For the small values of p and q we have used here, this is possible. However, for “real” cryptographic parameters, V's computer would be unable to do this.) Thus, if V's computer has submitted an encrypted ballot which does not correspond to V's choice, there are only two things it can do at the point it is expected to display a confirmation. It can display something, or it can display nothing. In the case that nothing is displayed, V may take this as an indication that the ballot was corrupted. In the case that something is displayed, what is displayed will almost certainly be wrong, and again, V may take this as an indication that the ballot was corrupted.
5. V now compares the value of C displayed to the value found in V's confirmation dictionary corresponding to the choice, “Green” (V's intended choice). At this point, V may have already received his confirmation dictionary in advance, or may obtain a copy through any independent channel. An example of such a channel would be to use a fax machine. If the displayed value does not match the corresponding confirmation string in the confirmation dictionary, corruption is detected, and the ballot can be “recast” in accordance with election-specific policy.

Each voter confirmation dictionary is computed by the vote collection center, since, as described above, it is the entity which has knowledge of the voter specific values of α and K. For the case of the voter, V, we have been considering, the dictionary is computed as

| Choice | Confirmation String |
|---|---|
| “Blue” | C₁ = Kμ₁^{β} = 37 × 9¹⁸ = 16 |
| “Green” | C₂ = Kμ₂^{β} = 37 × 21¹⁸ = 18 |
| “Red” | C₃ = Kμ₃^{β} = 37 × 36¹⁸ = 36 |
| “I abstain” | C₄ = Kμ₄^{β} = 37 × l7¹⁸ = 8 |

The level of security provided by the facility when using the SVC scheme is described hereafter: Let A be the vote client adversary, and let ε₀ be an upper bound on the probability that A is able to forge a validity proof for any given μ₁, . . . ,μ_{K}. (We know that ε₀ is negligible.)

Theorem 1 Suppose the SVC scheme is executed with H=Id. Fix 1≦k₁≠k₂≦K. Suppose that for some ε>0, A can, with probability ε, submit bᵢ=(g^{α}^{ᵢ}, h^{α}^{ᵢ}μₖ_{₁}), and display Cᵢₖ_{₂}=Kᵢμₖ_{₂}^{β}^{ᵢ}, where the probability is taken uniformly over all combinations of values for μ₁, . . . ,μ_{K}, g, h, βᵢ and Kᵢ. Then A can solve a random instance of the Diffie-Hellman problem with probability ε, and with O(K) additional work.

Proof: Suppose A is given X,Y,Zε_{R}<g>. A can simulate an election and SVC exchange by picking Cᵢₖ₁ε<g> and μₖε<g> independently at random for all k≠k₂, setting h=X,h^{β}^{ᵢ}=Y and μₖ₂=μₖ₁Z. The resulting distribution on the election parameters and Cᵢₖ_{₁} is obviously identical to the distribution that arises from real elections. With probability ε, A can display Cᵢₖ_{₂}, so can compute
C=Cᵢₖ_{₂}/Cᵢₖ_{₁}=(μₖ_{₂}/μₖ_{₁})^{β}^{ᵢ}=Z^{β}^{ᵢ} (20)
So log_{X}C=βᵢlogₕZ=log_{X}Y log_{X}Z, and C is the solution to the Diffie-Hellman problem instance posed by the triple (X,Y,Z).
Corollary 1 Suppose again that the SVC scheme is executed with H=Id. Fix 1≧k₂≧K. Suppose that for some ε₁>0, A can, with probability ε₁, choose k₁≠k₂. submit bᵢ=(g^{α}^{ᵢ}, h^{α}^{ᵢ}μₖ_{₁}), and displays Cᵢₖ_{₂}=Kᵢμₖ_{₂}^{β}^{ᵢ}, where the probability is taken uniformly over all combinations of values for μ₁, . . . ,μ_{K}, g, h, βᵢ and Kᵢ. Then A can solve a random instance of the Diffie-Hellman problem with probability ε₁/(K−1), and with O(K) additional work.
Proof: Follow the arguments of theorem 1, but compare to the problem of finding the solution to at least one of K−1 independent Diffie-Hellman problems.
Corollary 2 Let ε_{DH} be an upper bound on the probability that A can solve a random Diffie-Hellman instance. Then, in the case that H=Id, an upper bound on the probability that A can submit a vote that differs from the voter's choice, and yet display the correct confirmation string is ε₀+(K−1) ε_{DH}.

If the hash function H is non-trivial, we can not hope to make comparisons to the computational Diffie-Hellman problem without considerable specific knowledge of the properties of H. Rather than consider the security of the scheme with specific choices of H, we assume only that H has negligible collision probability, and instead compare security with the Decision Diffie-Hellman Problem. The variant of this problem we consider is as follows. A is given a sequence of tuples, (Xₙ,Yₙ,Zₙ,Cₙ), where Xₙ,Yₙ,Zₙ are generated independently at random. With probability ½, Cₙ is the solution to the Diffie-Hellman instance, (Xₙ,Yₙ,Zₙ), and with probability 1−½=½, Cₙ is generated randomly and independently. A is said to have an ε-DDH advantage if A can, with probability ½+ε, answer the question

$${log}_{{X}_{n}} {C}_{n} {=}^{?} {log}_{{X}_{n}} {Y}_{n} {log}_{{X}_{n}} {Z}_{n} .$$

Theorem 1, and corollaries 1 and 2 have obvious analogs in the case H≠Id (assuming only that H has negligible collision probability). Both the statements and proofs are constructed with minor variation, so we only summarize with:

Corollary 3 Let ε_{DDH} be an upper bound on A's DDH advantage. Then, if H is any hash function with negligible collision probability, an upper bound on the probability that A can submit a vote that differs from the voter's choice, and yet display the correct confirmation string is ε₀+(K−1)ε_{DDH}.

SVC may not offer any protection if the adversary, A, also controls the vote collection center. If this were the case, A has access to Kᵢ and βᵢ, and thus can easily display any valid confirmation string of its choosing. It seems unlikely that this would happen, since the vote collection center would be undeniably implicated in the event that such activity is discovered. Nevertheless, in case it is unacceptable to trust the vote collection center in this regard, the “confirmation responsibility” can be distributed among arbitrarily many authorities.

To distribute the confirmation responsibility, each authority, Aⱼ, 1≦j≦J, generates (for voter νᵢ) independent random Kᵢⱼ and βᵢⱼ. The authorities can combine these by two general methods.
1. Concatenation. The voter's confirmation string is computed as a concatenation, in pre-specified order, of the individual confirmation strings (computed separately as in the previous section) corresponding to each of the J authorities. In this case, confirmation is successful only if all of the substrings verify correctly.
2. Trusted Server or Printer. If it is acceptable to trust a single central server, or printer, the multiple confirmation strings can be combined into one of the same size by simply computing

$$\begin{matrix}{W}_{i} = {\prod }_{j = 1}^{J} {W}_{ij} & ( 21 ) \\ {U}_{i} = {\prod }_{j = 1}^{J} {U}_{ij} & ( 22 )\end{matrix}$$
This has the advantage of reducing the amount of confirmation data that must be transmitted to the voter, but at the cost of creating a central point of attack for the system.

It is always desirable to reduce the size of the data that must be sent to the voter via the independent channel. As described in section 3, the confirmation dictionary is already small by the standards of modern communications technology, but it may be cost advantageous if even less data can be transmitted. As mentioned above, one approach might be to send the secrets Kᵢ and βᵢ directly to the voter, but this has the disadvantage of putting a computational burden on the voter that is too large to be executed “in the voter's head,” or “on paper.” The following variation on the SVC scheme achieves both goals—less data through the independent communication channel, and “mental computation” by the voter. It comes at a cost, namely that the probability that a client adversary may be able to fool the voter is increased, however, this may be quite acceptable from the overall election perspective. Even if the probability of the adversary going undetected is, say ½, in order for it to change a substantial fraction of votes, the probability that it will be detected by a statistically significant fraction of voters will be very high. As discussed in the introduction, remedial measures are possible.

The idea is to deliver the entire set of confirmation strings to the voter via the suspect client, but in randomly permuted order. The only additional piece of information that the voter needs then is the permutation that was used. This isn't quite enough, in this scenario, since all the confirmation strings are available, the adversary can gain some advantage simply by process of elimination. (The case K=2 is particularly useful to consider.) In order to increase the security, we include with the dictionary, several random confirmation strings, that are also permuted.

The steps in subsection 3.1 are executed as before. In addition, the vote collection sends to the client, Mᵢ, a “randomized dictionary,” Dᵢ. This is created by the vote collection center, C, as follows:
RD-1. The K (voter specific) confirmation strings
   (Sᵢ₁, . . . ,S_{iK})=(H(Cᵢ₁), . . . ,H(C_{iK})) (23)
are computed as before.
RD-2. Additionally, L extra strings are generated as
   (S_{i(K+1)}, . . . ,S_{i(K+L)})=(H(g^{e}^{₁}), . . . ,H(g^{e}^{_{L}})) (24)
where the e₁, . . . ,e_{L} are generated independently at random in Z_{q}.
RD-3. A random permutation, σᵢεΣ_{K+L} is generated.
RD-4. C sets Qᵢⱼ=S_{iσi(j)}, for 1≦j≦K+L, and sets Dᵢ to be the sequence of strings (Qᵢ₁, . . . Q_{i(K+L)}).

If C sends some “human readable” representation of σᵢ to νᵢ, through an independent channel, νᵢ can now verify her vote by simply finding the confirmation string with the proper index. We denote this scheme by SVCO.

With respect to the level of security of SVCO, consider the following form of the Diffie-Hellman Decision Problem: A is given a sequence of tuples, (Xₙ,Yₙ,Zₙ,Cₙ,Dₙ), where Xₙ, Yₙ,Zₙ, are generated independently at random. Let Rₙ be generated independently at random, and let Oₙ be the solution to log_{Xn}Oₙ=log_{Xn}Yₙlog_{Xn}Zₙ. With probability ½, (Cₙ,Dₙ)=(Oₙ,Rₙ), and with probability 1−½=½, (Cₙ,Dₙ)=(Rₙ,Oₙ). A is said to have an ε-DDHP advantage if A can, with probability ½+ε, answer the question log_{Xn}Cₙ=log_{Xn} Yₙ log_{Xn} Zₙ. That is, A must answer the same question as in the original version of the problem, but the problem may be easier because more information is available.
Theorem 2 Let ε_{DDHP} be an upper bound on A's DDHP advantage, and H any hash function with negligible collision probability. An upper bound on the probability, under the SVCO scheme, that A can submit a vote that differs from the voter's choice, and yet display the correct confirmation string is

$${∈}_{0} + ( \frac{K + L}{L} ) {∈}_{DDHP} \qquad ( 25 )$$

Proof: As in the proof of theorem 1, A can simulate an election and SVCO exchange. In this case, however, A must also simulate the list of confirmation strings that were not available in the SVC scheme. For k₁, k₂ fixed, A can pick Cᵢₖ_{₁}ε<g> at random, and for all k≠k₂, pick θₖεZ_{q} independently at random. A then sets μₖ=X^{θ}^{ₖ}. For k≠k₁,k₂, A sets Cᵢₖ=Cᵢₖ_{₁}Y^{θ}^{ₖ}^{-θ}^{ₖ₁}. A sets μ_{kdi 2}=μₖ_{₁}Z, and generates L additional random μₗ and l−1 additional Cᵢₗ at random. Finally, A sets Cᵢₖ_{₂}=Cᵢₖ_{₁}Cₙ, and the last remaining Cᵢₗ=Cᵢₖ_{₁}Dₙ. As before, finding the right confirmation string is equivalent to deciding which of the values, Cₙ, Dₙ is the correct Diffie-Hellman solution. Averaging over all permutations with uniform probability gives the result.

Below is described one possible alternative to the secret vote confirmation scheme described above. The level of security between those two schemes is essentially equivalent.
1. In addition to the election public key, h, the vote collection publishes another public key of the form \overline{h}=h^{d}, where dεZ_{q} is a secret known only to the vote collection center.
2. The client, Mᵢ, submits a an encrypted ballot on behalf of νᵢ as before, but redundantly encrypted with both h and \overline{h}. We denote the second encryption by
   (\overline{X}ᵢ, \overline{Y}ᵢ)=(g^{\overline{α}}^{ᵢ},\overline{h}^{\overline{α}}m) (26)
Where \overline{α}ᵢ is selected independently of αᵢ.
3. Mᵢ also constructs a simple proof of validity (essentially a single Chaum-Pedersen proof) that the two are encryptions of the same value.
4. If the proof of validity does not pass at the vote collection center, corruption is detected as before.
5. The vote collection center selects random Kᵢε<g>; βᵢεZ_{q}, and computes
   Tᵢ=Yᵢ^{dβ}^{ᵢ}=(h^{α}^{ᵢ})^{dβ}^{ᵢ}m^{dβ}^{ᵢ} (27)
   Wᵢ=\overline{Y}ᵢ^{β}^{ᵢ}=(h^{\overline{α}}^{ᵢ})^{β}^{ᵢ}m^{β}^{ᵢ} (28)
   Vᵢ=KᵢTᵢWᵢ=Kᵢ\overline{h}^{β}^{ᵢ}^{(α}^{ᵢ}^{+\overline{α}}^{ᵢ})m^{(d+1)β}^{ᵢ} (29)
6. The vote collection center returns \overline{h}^{β}ᵢ and Vᵢ to Mᵢ.
7. Mᵢ computes Sᵢ=Kᵢm^{(d+}1)β^{ᵢ} by the equation

$${S}_{i} = {K}_{i} {m}^{( d + 1 ) {β}_{i}} = \frac{{V}_{i}}{{( {\overline{h}}^{{β}_{i}} )}^{( {α}_{i} + {{\overline{α}}_{i}}^{)}}} \qquad ( 30 )$$
and displays this value (or, H(Sᵢ)) to the voter, νᵢ.
8. The voter requests a confirmation dictionary as before, and checks against the displayed value.

In the case of detected corruption, corrective action is taken as before.

The description of the facility above describes using a single d (and therefore a single \overline{h}=h^{d}) for all voters and publishing this value in advance of the election.

Alternatively, the vote collection center (or distributed set of “confirmation authorities”) issues an independent, random dᵢ (and therefore \overline{h}ᵢ=h^{d}^{ᵢ}) for each voter, νᵢ. The value dᵢ is always kept secret, but the value \overline{h}ᵢ is communicated to νᵢ.

In one embodiment, the facility communicates \overline{h}ᵢ to νᵢ as follows:
A-1 νᵢ contacts the vote collection center and authenticates himself/herself
A-2 Assuming authentication is successful, the vote collection center:
   1. Generates dᵢ randomly
   2. Computes \overline{h}ᵢ=h^{d}^{₁}
   3. Sends \overline{h}ᵢ to νᵢ
A-3 The voter, νᵢ then proceeds as described above with \overline{h}ᵢ in place of \overline{h}

In another embodiment, the facility communicates \overline{h}ᵢ to νᵢ as follows:
B-1 νᵢ contacts vote collection center (and optionally authenticates himself/herself)
B-2 νᵢ makes ballot choice mᵢ, and returns the encrypted ballot (g^{α}^{ᵢ},h^{α}^{ᵢ}mᵢ)
B-3 The vote collection center at this point:
   1. Generates dᵢ randomly
   2. Computes \overline{h}ᵢ=h^{d}^{ᵢ}
   3. Sends \overline{h}ᵢ to νᵢ
B-4 Voter, νᵢ then
   1. Generates second encryption of mᵢ as (g^{\overline{α}}^{ᵢ},\overline{h}ᵢ^{\overline{α}}^{ᵢ}mᵢ)
   2. Generates same proof of validity showing that first and second encryptions are encryptions of the same ballot choice, mᵢ
   3. Sends both the second encryption, and the proof of validity to the ballot collection agency
B-5 The rest of the confirmation process proceeds as described above

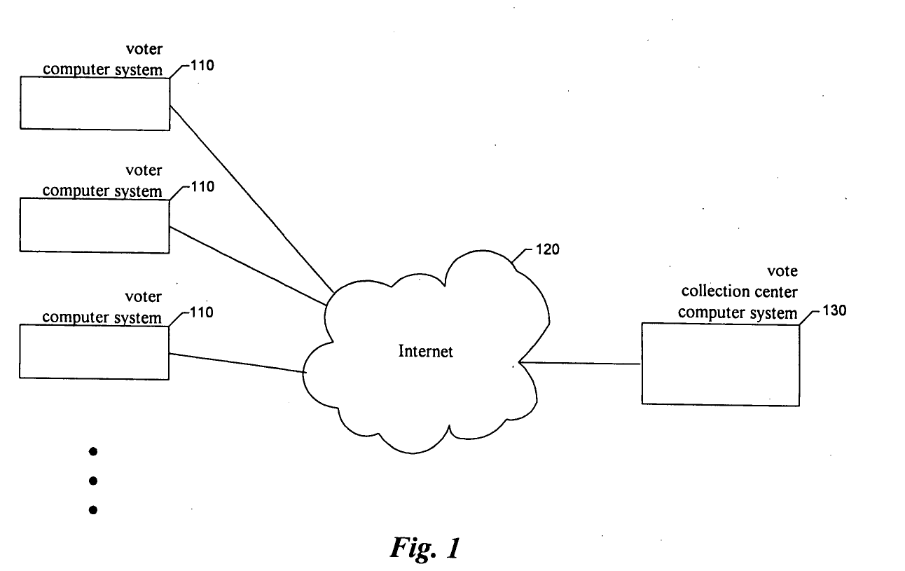

FIGS. 1-3 illustrate certain aspects of the facility. FIG. 1 is a high-level block diagram showing a typical environment in which the facility operates. The block diagram shows several voter computer systems 110, each of which may be used by a voter to submit a ballot and verify its uncorrupted receipt. Each of the voter computer systems are connected via the Internet 120 to a vote collection center computer system 150. Those skilled in the art will recognize that voter computer systems could be connected to the vote collection center computer system by networks other than the Internet, however. The facility transmits ballots from the voter computer systems to the vote collection center computer system, which returns an encrypted vote confirmation. In each voter computer system, the facility uses this encrypted vote confirmation to determine whether the submitted ballot has been corrupted. While preferred embodiments are described in terms in the environment described above, those skilled in the art will appreciate that the facility may be implemented in a variety of other environments including a single, monolithic computer system, as well as various other combinations of computer systems or similar devices connected in various ways.

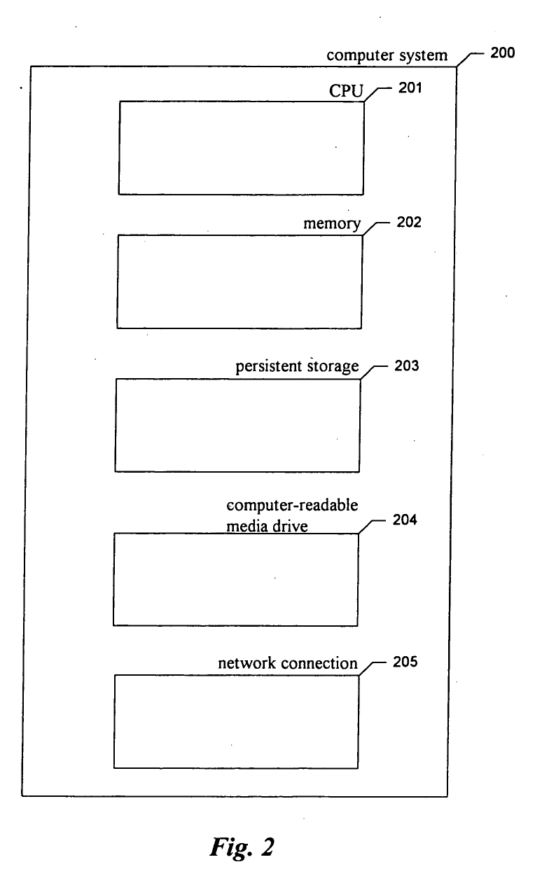

FIG. 2 is a block diagram showing some of the components typically incorporated in at least some of the computer systems and other devices on which the facility executes, such as computer systems 110 and 130. These computer systems and devices 200 may include one or more central processing units (“CPUs”) 201 for executing computer programs; a computer memory 202 for storing programs and data while they are being used; a persistent storage device 203, such as a hard drive for persistently storing programs and data; a computer-readable media drive 204, such as a CD-ROM drive, for reading programs and data stored on a computer-readable medium; and a network connection 205 for connecting the computer system to other computer systems, such as via the Internet. While computer systems configured as described above are preferably used to support the operation of the facility, those skilled in the art will appreciate that the facility may be implemented using devices of various types and configurations, and having various components.

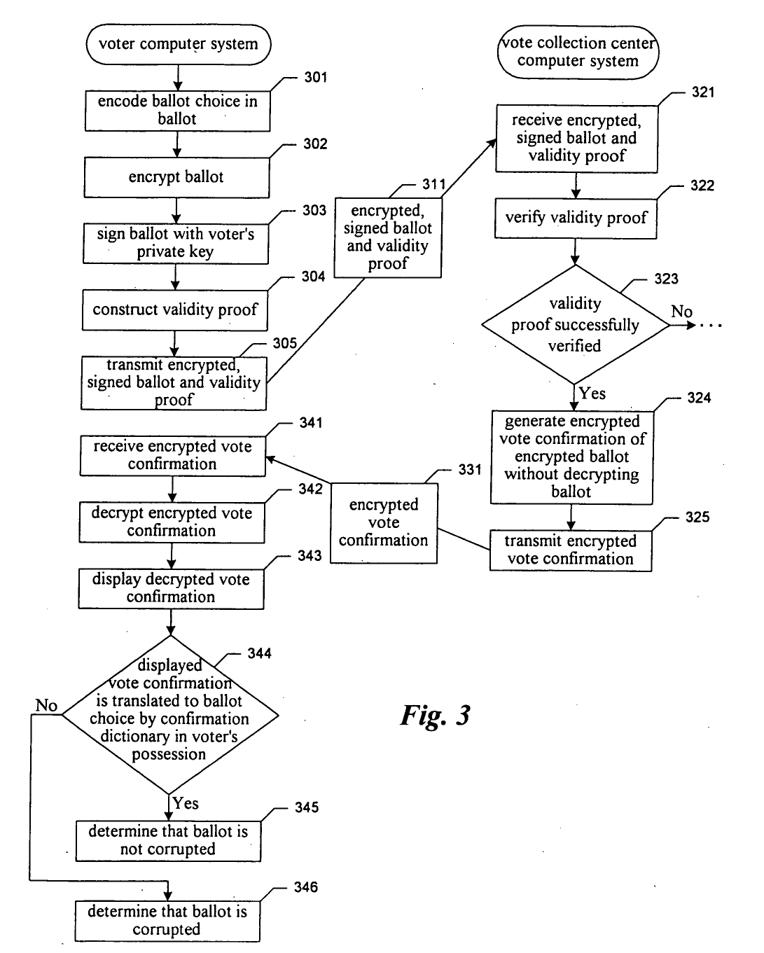

FIG. 3 is a flow diagram showing steps typically performed by the facility in order to detect a compromised ballot. Those skilled in the art will appreciate that the facility may perform a set of steps that diverges from those shown, including proper supersets and subsets of these steps, reorderings of these steps, and steps of sets in which performance of certain steps by other computing devices.

In step 301, on the voter computer system, the facility encodes a ballot choice selected by the voter in order to form a ballot. In step 302, the facility encrypts this ballot. In some embodiments, the encrypted ballot is an ElGamal pair, generated using an election public key and a secret maintained on the voter computer system. In step 303, the facility optionally signs the ballot with a private key belonging to the voter. In step 304, the facility constructs a validity proof that demonstrates that the encrypted ballot is the encryption of a ballot in which a valid ballot choice is selected. In step 305, the facility transmits the encrypted, signed ballot and the validity proof to a vote collection center computer system.

In step 321, the facility receives this transmission in the vote collection center computer system. In step 322, the facility verifies the received validity proof. In step 323, if the validity proof is successfully verified, then the facility continues with 324, else the facility does not continue in step 324. In step 324, the facility generates an encrypted confirmation of the encrypted ballot. The facility does so without decrypting the ballot, which is typically not possible in the vote collection center computer system, where the secret used to encrypt the ballot is not available. In step 325, the facility transmits the encrypted confirmation 331 to the voter computer system.

In step 341, the facility receives the encrypted vote confirmation in the voter computer system. In step 342, the facility uses the secret maintained on the voter computer system to decrypt the encrypted vote confirmation. In step 343, the facility displays the decrypted vote confirmation for viewing by the user. In step 344, if the displayed vote confirmation is translated to the ballot choice selected by the voter by a confirmation dictionary in the voter's possession, then the facility continues in step 345, else the facility continues in step 346. In step 345, the facility determines that the voter's ballot is not corrupted, whereas, in step 346, the facility determines that the voter's ballot is corrupted. In this event, embodiments of the facility assist the user in revoking and resubmitting the voter's ballot.

It will be appreciated by those skilled in the art that the above-described facility may be straightforwardly adapted or extended in various ways. While the foregoing description makes reference to preferred embodiments, the scope of the invention is defined solely by the claims that follow and the elements recited therein.

1.-26. (canceled)

27. A method in a computing system for delivering a ballot choice selected by a voter, comprising:
in a client computer system:
encrypting the ballot choice with a first secret known only to the client to generate a first encrypted ballot component;
encrypting the ballot choice with a second secret known only to the client, the second secret chosen independently of the first secret, to generate a second encrypted ballot component;
generating a proof demonstrating that the first and second encrypted ballot components are encrypted from the same ballot choice; and
sending the first and second ballot components and the proof to a vote collection computer system;
in the vote collection computer system:
determining whether the proof demonstrates that the first and second encrypted ballot components are encrypted from the same ballot choice; and
only if the proof demonstrates that the first and second encrypted ballot components are encrypted from the same ballot choice, accepting the ballot choice.

28. The method of claim 27 wherein the first encrypted ballot component is generated by evaluating g^{α} and h^{α}m, where p is prime; gεZₚ, which has prime multiplicative order q, with the property that q is a multiplicity 1 divisor of p−1; hε<g>; αεZ_{q} is chosen randomly at the voting node; and m is the ballot choice and wherein the second encrypted ballot component is generated by evaluating the expressions g^{\overline{α}} and \overline{h}^{\overline{α}}m, where \overline{h}ε<g>; \overline{α}εZ_{q} is chosen randomly and independently at the voting node; and m is the ballot choice.

29. The method of claim 27, further comprising:
in the vote collection computer system, sending to the client computer system a ballot confirmation based on the first and second encrypted ballot components; and
in the client computer system, decrypting the ballot confirmation using the first and second secrets.

30. The method of claim 29, further comprising generating the ballot confirmation by evaluating the expression
Vᵢ=Kᵢ\overline{h}^{β}^{ᵢ}^{(α}^{ᵢ}^{+\overline{α}}^{ᵢ}⁾m^{(d+1)β}^{ᵢ}
Where p is prime; gεZₚ, which has prime multiplicative order q, with the property that q is a multiplicity 1 divisor of p−1; hε<g>; \overline{h}ε is h raised to the power d which is maintained as a secret; αεZ_{q} and \overline{α}εZ_{q} are chosen randomly and independently at the voting node; Kᵢε<g>; βᵢεZ_{q}; and m is the ballot choice, and by evaluating the expression
\overline{h}^{β}^{ᵢ}
and wherein these two evaluated expressions are sent to the client computer system as the ballot confirmation.

31. The method of claim 29 wherein the ballot confirmation is decrypted by evaluating
$$\frac{{V}_{i}}{{( {\overline{h}}^{{β}_{i}} )}^{( {α}_{i} + {{\overline{α}}_{i}}^{)}}}$$
where p is prime; gεZₚ, which has prime multiplicative order q, with the property that q is a multiplicity 1 divisor of p−1; hε<g>; \overline{h}ε is h raised to the power d which is maintained as a secret; αεZ_{q} and \overline{α}εZ_{q} are chosen randomly and independently at the voting node; Kᵢε<g>; \overline{β}ᵢεZ_{q}; and Vᵢ is received as part of the ballot confirmation.

32. A method in a computing system for transmitting a ballot choice selected by a voter, comprising:
encrypting the ballot choice with a first secret known only to the client to generate a first encrypted ballot component;
encrypting the ballot choice with a second secret known only to the client, the second secret chosen independently of the first secret, to generate a second encrypted ballot component;
generating a proof demonstrating that the first and second encrypted ballot components are encryptions of the same ballot choice; and
sending the first and second encrypted ballot components and the proof to a vote collection computer system.

33. A computer-readable medium whose contents cause a computing system to submit a ballot choice selected by a voter by:
encrypting the ballot choice with a first secret known only to the client to generate a first encrypted ballot component;
encrypting the ballot choice with a second secret known only to the client, the second secret chosen independently of the first secret, to generate a second encrypted ballot component;
generating a proof demonstrating that the first and second encrypted ballot components are encryptions of the same ballot choice; and
sending the first and second ballot components and the proof to a vote collection computer system.

34. One or more generated data signals together conveying an encrypted ballot data structure, comprising:
a first encrypted ballot choice encrypted with a first secret known only to a client computer system to generate a first encrypted ballot component,
a second encrypted ballot choice encrypted with a second secret known only to the client computer system, the second secret chosen independently of the first secret, and
a proof; and
such that the ballot represented by the encrypted ballot data structure may be counted only where the proof demonstrates that the first and second encrypted ballot choices are encryptions of the same ballot choice.

35. A method in a computing system for receiving a ballot choice selected by a voter, comprising:
receiving from a client computer system:
a first encrypted ballot choice encrypted with a first secret known only to the client to generate a first encrypted ballot component,
a second encrypted ballot choice encrypted with a second secret known only to the client, the second secret chosen independently of the first secret, and
a proof; and
only where the proof demonstrates that the first and second encrypted ballot choices are encryptions of the same ballot choice, accepting the ballot choice.

36. A computer-readable medium whose contents cause a computing system to receive a ballot choice selected by a voter by:
receiving from a client computer system:
a first encrypted ballot choice encrypted with a first secret known only to the client to generate a first encrypted ballot component,
a second encrypted ballot choice encrypted with a second secret known only to the client, the second secret chosen independently of the first secret, and
a proof; and
only where the proof demonstrates that the first and second encrypted ballot choices are encryptions of the same ballot choice, accepting the ballot choice.

37. A computer-readable medium whose contents cause a computing system to perform a method for delivering a ballot choice selected by a voter, the method comprising:
in a client computer system:
encrypting the ballot choice with a first secret known only to the client to generate a first encrypted ballot component;
encrypting the ballot choice with a second secret known only to the client, the second secret chosen independently of the first secret, to generate a second encrypted ballot component;
generating a proof demonstrating that the first and second encrypted ballot components are encrypted from the same ballot choice; and
sending the first and second ballot components and the proof to a vote collection computer system;
in the vote collection computer system:
determining whether the proof demonstrates that the first and second encrypted ballot components are encrypted from the same ballot choice; and
only if the proof demonstrates that the first and second encrypted ballot components are encrypted from the same ballot choice, accepting the ballot choice.

38. The computer-readable medium of claim 37 wherein the first encrypted ballot component is generated by evaluating g^{α} and h^{α}m, where p is prime; gεZₚ, which has prime multiplicative order q, with the property that q is a multiplicity 1 divisor of p−1; hε<g>; αεZ_{q} is chosen randomly at the voting node; and m is the ballot choice and wherein the second encrypted ballot component is generated by evaluating the expressions g^{\overline{α}} and \overline{h}^{\overline{α}}m, where \overline{h}ε<g>; \overline{α}εZ_{q} is chosen randomly and independently at the voting node; and m is the ballot choice.

39. The computer-readable medium of claim 37, the method further comprising:
in the vote collection computer system, sending to the client computer system a ballot confirmation based on the first and second encrypted ballot components; and
in the client computer system, decrypting the ballot confirmation using the first and second secrets.

40. The computer-readable medium of claim 39, the method further comprising generating the ballot confirmation by evaluating the expression
Vᵢ=Kᵢ\overline{h}^{β}^{ᵢ}^{(α}^{ᵢ}^{+\overline{α}}^{ᵢ}⁾m^{(d+1)β}^{ᵢ}
Where p is prime; gεZₚ, which has prime multiplicative order q, with the property that q is a multiplicity 1 divisor of p−1; hε<g>; \overline{h}ε is h raised to the power d which is maintained as a secret; αεZ_{q} and \overline{α}εZ_{q} are chosen randomly and independently at the voting node; Kᵢε<g>; βᵢεZ_{q}; and m is the ballot choice, and by evaluating the expression
\overline{h}^{β}^{ᵢ}
and wherein these two evaluated expressions are sent to the client computer system as the ballot confirmation.

41. The computer-readable medium of claim 39 wherein the ballot confirmation is decrypted by evaluating
$$\frac{{V}_{i}}{{( {\overline{h}}^{{β}_{i}} )}^{( {α}_{i} + {{\overline{α}}_{i}}^{)}}}$$
where p is prime; gεZₚ, which has prime multiplicative order q, with the property that q is a multiplicity 1 divisor of p−1; hε<g>; \overline{h}ε is h raised to the power d which is maintained as a secret; αεZ_{q} and \overline{α}εZ_{q} are chosen randomly and independently at the voting node; Kᵢε<g>; \overline{β}ᵢεZ_{q}; and Vᵢ is received as part of the ballot confirmation.
